(19) United States
(12) Patent Application Publication
(10) Pub. No.: US 2008/0319851 A1
(43) Pub. Date: Dec. 25, 2008

(54) Using delegation for distributing protected content

(75) Inventors: Alexandre V. Grigorovitch, Redmond, WA (US); James M. Alkove, Woodinville, WA (US); Muthukrishnan Paramasivan, Naperville, IL (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,654

(22) Filed: Jun. 25, 2007

(51) Int. Cl. G06Q 30/00; G06Q 99/00

(52) U.S. Cl. 705/14; 705/1

(57) ABSTRACT

In various embodiments, a content distribution model is provided in which content providers that own content can distribute their content to third-party content distributors who are unaffiliated with the content providers. The content distributors can, in turn, manipulate the content to provide supplemental content, such as advertising and the like, and then distribute the manipulated content to users who are authorized to consume the content. In this way, content providers are relieved of the responsibility of owning or controlling how such other supplemental content is integrated with their protected content. In this manner, manipulation of the content is delegated to third party content distributors. In one or more embodiments, a ticket-based approach is used as a basis to authenticate that third-party distributors are, in fact, authorized to distribute presentations that include the content provider's content. The ticket-based approach can be used for both server-based verification and client-based verification scenarios.

### BACKGROUND

Today when digital content such as multimedia like movies and other content is distributed over a network such as the Internet, it is typically encoded and encrypted and stored on a server. The content is usually encrypted with some type of key. In some distribution models, a content provider that owns the content can provide a license server that has access to the key, an indication of those who have purchased a license to consume the content. When a user wishes to consume digitally-protected content, there is typically some type of transaction with the license server that takes place. For example, the user may pay for a license or may pay for a license subscription to a variety of content. During the transaction with the license server, the user provides some sort of authentication that indicates who the user is and the nature of the license they have purchased.

If the user is authenticated, then the license server can provide a license that allows the user to decrypt and consume the content. In many instances, there is no easy way for a content provider to delegate actions to a third party content distributor who is otherwise unaffiliated with the content provider. Specifically, presently there is no easy way for the content provider to distribute its content to a third party distributor, and then have the third-party distributor in some way manipulate the content to build a business model around it.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In various embodiments, a content distribution model is provided in which content providers that own content can distribute their content to third-party content distributors who are unaffiliated with the content providers. The content distributors can, in turn, manipulate the content to provide supplemental content, such as advertising and the like, and then distribute the manipulated content to users who are authorized to consume the content. In this way, content providers are relieved of the responsibility of owning or controlling how such other supplemental content is integrated with their protected content. In this manner, manipulation of the content is delegated to third party content distributors.

In one or more embodiments, a ticket-based approach is used as a basis to authenticate that third-party distributors are, in fact, authorized to distribute presentations that include the content provider's content. The ticket-based approach can be used for both server-side and client-side verification scenarios.

### BRIEF DESCRIPTION OF THE DRAWINGS

The same numbers are used throughout the drawings to reference like features.

FIG. 1 illustrates an operating environment in accordance with one or more embodiments.

FIG. 2 illustrates aspects of the FIG. 1 operating environment in accordance with one or more embodiments.

FIG. 3 is a flow diagram that describes steps in a method in accordance with one or more embodiments.

FIG. 4 illustrates the FIG. 1 operating environment in accordance with one or more embodiments.

FIG. 5 is a flow diagram that describes steps in a method in accordance with one or more embodiments.

FIG. 6 illustrates an example system in accordance with one or more embodiments.

### DETAILED DESCRIPTION

Overview

In various embodiments, a content distribution model is provided in which content providers that own content can distribute their content to third-party content distributors who are unaffiliated with the content providers. The content distributors can, in turn, manipulate the content to provide supplemental content, such as advertising and the like, and then distribute the manipulated content to users who are authorized to consume the content. In this way, content providers are relieved of the responsibility of owning or controlling how such other supplemental content is integrated with their protected content. In this manner, manipulation of the content is delegated to third party content distributors.

In one or more embodiments, a ticket-based approach is used as a basis to authenticate that third-party distributors are, in fact, authorized to distribute presentations that include the content provider's content. The ticket-based approach can be used for both server-based verification and client-based verification scenarios.

In the discussion that follows, a section entitled “Operating Environment” is provided and describes an example operating environment in accordance with one or more embodiments. After that, a section entitled “Implementation Example—Server-side Verification” is provided and describes embodiments in which verification can take place on the server side. Following this section, a section entitled “Implementation Example—Client-side Verification” is provided and describes examples in which verification can take place on the client side. Last, a section entitled “Example Computing Device” is provided and describes an example computing device that can be used to implement one or more embodiments.

Operating Environment

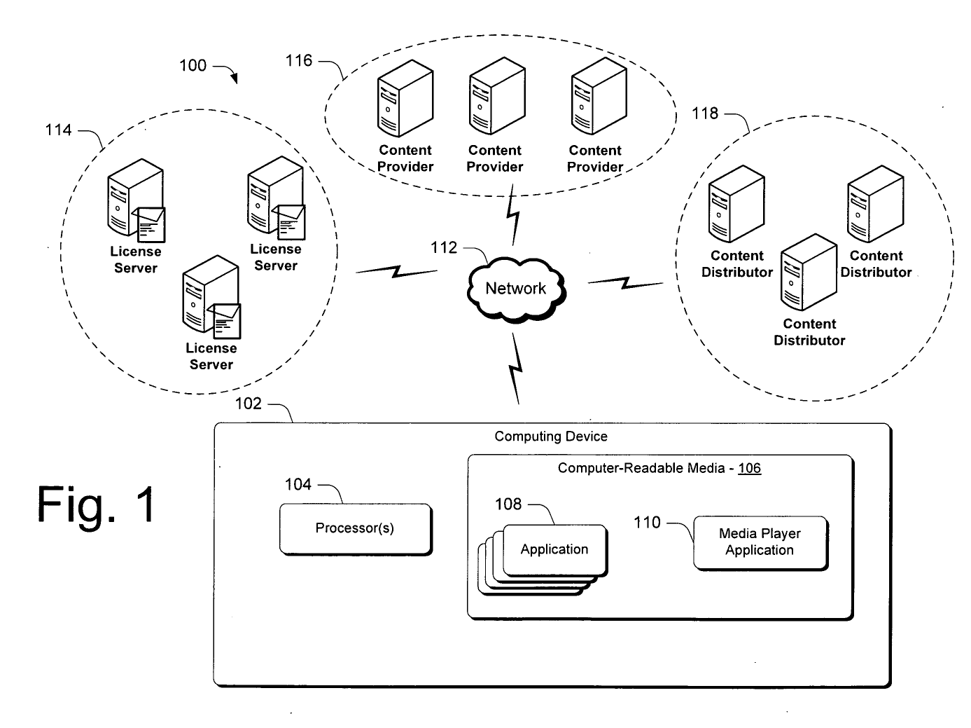

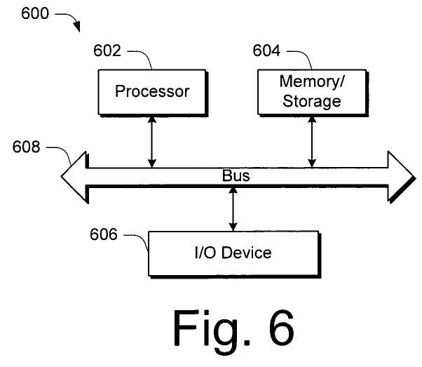

FIG. 1 illustrates an operating environment in accordance with one or more embodiments, generally at 100. Environment 100 includes one or more computing devices 102 having one or more processors 104, one or more computer-readable media 106 and one or more applications 108 that reside on the computer-readable media and which are executable by the processor(s). The computer-readable media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

In addition, computing device 102 includes a media player application 110 that can be utilized to play protected media content that is received by the computing device, as will become apparent below. Any suitable media player application can be utilized, examples of which are available from the assignee of this document and others.

Computing device 102 can be embodied as any suitable computing device such as, by way of example and not limitation, a desktop computer, a portable computer, a handheld computer such as personal digital assistants (PDA), cell phone, and the like.

In addition, environment 100 includes a network 112, such as the Internet or some other suitable network that allows computing device 102 to communicate with a variety of entities that are involved in some way with one or more of distribution or protection of digital content. The example provided just below is intended to provide the reader with a basic overview of example entities and/or functionality that can exist within operating environment 100. The description is not intended to limit application of the claimed subject matter to one particular operating environment or type of operating environment.

Accordingly, in this particular example, such entities or functionality can include, by way of example and not limitation, various license servers 114, content providers 116 and content distributors 118.

In one or more embodiments, the license servers 114 are configured to serve digital rights management (DRM) licenses to various computing devices. The DRM licenses typically describe and define the terms of use of a particular piece of content. In addition, the DRM licenses can contain keys that allow content that has been protected by encryption to be decrypted.

Content providers 116 are configured to serve content that is governed by one or more licenses that can be distributed by the license servers 114. In many instances, the content providers own the content that is being distributed. So, for example, in the multimedia context, the content providers can own the multimedia content that is to be distributed by content distributors 118.

Content distributors 118 can comprise any type of third-party content distributor that distributes content to computing devices such as computing device 102. Many times, these content distributors are unaffiliated with content providers 116. In practice, content providers 116 will license content distributors 118 to distribute protected content. As part of the process of distributing the content from content providers 116, content distributors 118 can modify or add to the content in some way.

Many times, content distributors will build a business model surrounding the distribution of this content. For example, some content distributors may sell advertising space associated with content received from a content provider. The content distributors can then develop supplemental content in the form of advertising content and integrate the advertising content with the content received from the content providers. Accordingly, when a user receives content that originated with a particular content provider, included with this content will be supplemental content that has been added by the content distributors. So for example, a user who pays for a license to consume a particular movie may, in the process of consuming or attempting to consume that movie, be exposed to advertising that has been added by the content distributors.

In this example, the content provider has delegated the ultimate responsibility of designing and distributing a presentation package that includes its protected content. In the discussion below, a ticket-based approach is utilized to enable delegation of the responsibility of designing and distributing presentation packages that include protected content. In the approaches that are described below, both server-side and client-side verification scenarios can be enabled using the ticket-based approach. Each is discussed under its own heading.

Implementation Example—Server-Side Verification

In the example about to be described, a ticket-based approach is utilized to allow for delegation when distributing protected content. This approach is generally well-suited for use in online scenarios. Online scenarios include those scenarios where the user or, more accurately, the user's computing device is online and can communicate with a license server.

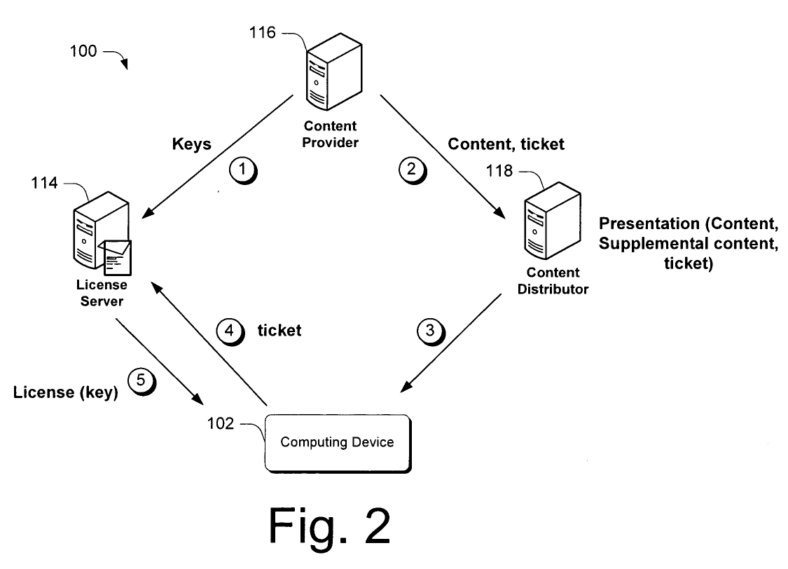

As an example, consider FIG. 2 which illustrates the FIG. 1 operating environment with a number of components removed for clarity. In this example, content provider 116 and license server 114 have separately negotiated a process by which licenses can be served to users for content that has been protected. Part of this process can involve providing various keys to the license server 114 for incorporation in licenses that are to be subsequently distributed.

In one or more embodiments, content provider 116 provides both protected content as well as a ticket associated with the protected content to content distributor 118. The content that is distributed to the content distributor can be encrypted with a key. In one or more embodiments, the ticket includes information that can be utilized to verify that content distributor 118 is an authorized distributor for the particular content that it distributes. Any suitable type of information can be utilized, and example of which is provided below.

When content distributor 118 receives the protected content and ticket from content provider 116, it can build a presentation that includes not only the protected content and ticket, but also supplemental content that it can add. Any suitable type of supplemental content can be utilized. For example, in some embodiments a content distributor's business model may be to sell advertising that is to be distributed with certain protected content. This advertising content can then be incorporated or integrated with the protected content in the content distributor's presentation. Other types of supplemental content can be utilized without departing from the spirit and scope of the claimed subject matter.

Having built its presentation, the content distributor 118 can now distribute its presentation to computing device 102. When an end-user on computing device 102 attempts to play the protected content, the computing-device's media player application communicates with license server 114 and sends the ticket that was included in the presentation to the license server. The license server can then use the ticket to verify that the presentation came from an authorized third-party content distributor who had previously received the ticket from content provider 116. If the ticket is verified, the license server can provide a license to computing device 102 that can be utilized to play the content in the presentation. In one or more embodiments, the license that is provided by license server 114 can include a key to decrypt or otherwise access the protected content.

The system of FIGS. 1 and 2 can, among other things, be utilized by content providers that do not wish to be associated with or involved in the process of using third-party business models to distribute their content. In at least some embodiments, content that is distributed from the content providers can remain encrypted and thus protected. Yet, by virtue of an agreement between the content providers and the content distributors, the content distributors are free to incorporate the protected content in their own presentations which can leverage their own business models in any suitable way. By using a ticket that includes a verifiable information, content providers can be assured that protected content that is distributed in the manner described above can be consumed by authorized users.

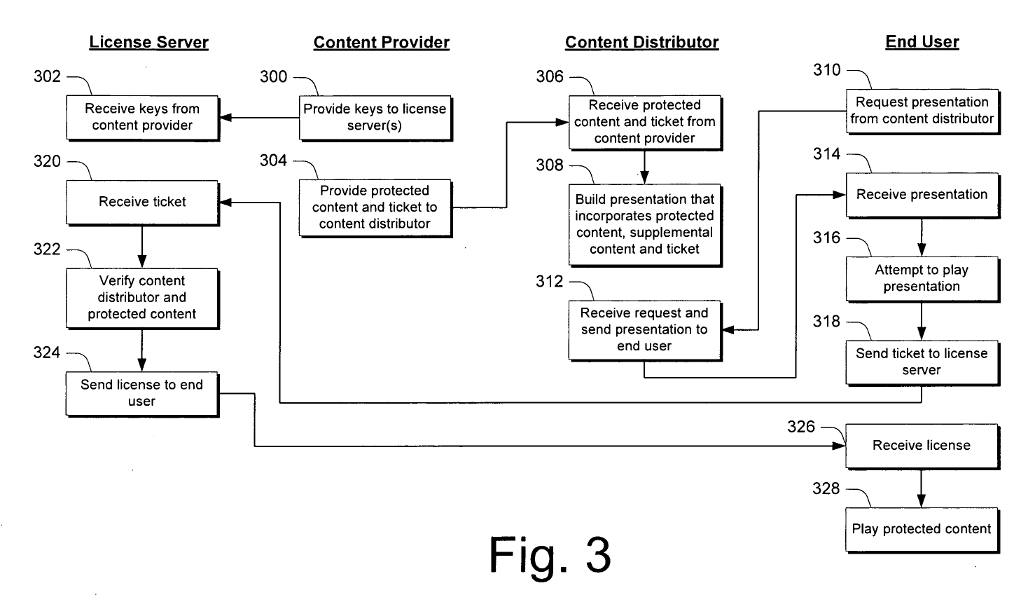

FIG. 3 is a flow diagram that describes steps in a content distribution method in accordance with one or more embodiments. The method can be implemented in connection with any suitable hardware, software, firmware or combination thereof. In at least some embodiments, the method can be implemented using a system such as that shown and described in FIGS. 1 and 2. In FIG. 3, various designations have been utilized to designate which entities perform which acts. For example, under the designation “License Server”, acts that are performed by a suitably configured license server appear. Further, acts that are performed by a content provider appear under the designation “Content Provider”, and so on.

Step 300 provides, by a content provider, one or more keys to one or more license servers. Any suitable keys can be provided to the license servers. In various embodiments, the keys can be utilized to decrypt or otherwise access content that has been protected. Step 302 receives, with a license server, the keys from the content provider. These keys are subsequently utilized by the license server in licenses that are provided to end users, as will become apparent below. Step 304 provides protected content and a ticket to one or more content distributors. Step 306 receives, with the content distributor, the content from the content provider as well as the ticket. Step 308 builds a presentation that incorporates protected content, supplemental content, and the ticket. Any suitable supplemental content can be utilized. But one example of such supplemental content is advertising material.

Step 310 requests, by the end-user, a presentation from a content distributor. Step 312 receives the request and sends the presentation to the end-user. Step 314 receives the presentation and step 316 attempts to play the presentation. In one or more embodiments, when the end-user attempts to play the presentation, step 318 sends the associated ticket to the license server. This step can be implemented in any suitable way. For example, when a user first opens the presentation, the associated ticket can be sent to the license server. To ensure security, the ticket can be signed or otherwise digitally protected.

Step 320 receives, with the license server, the ticket that was sent by the end-user. Step 322 verifies, using the ticket, that the content distributor is authorized to distribute the protected content associated with the ticket. Assuming the content distributor and the associated protected content are verified, step 324 sends a license to the end-user.

Step 326 receives the license that was sent from a license server, and utilizes the license, at step 328 to play the protected content. In one or more embodiments, the license includes a key that can be utilized to decrypt or otherwise access the protected content.

In the above-described embodiment, a ticket is utilized in a verification process that allows the license server to verify that the content distributor from which content is distributed is, in fact, authorized to distribute the particular content that has been received by the end-user. Characteristics of example tickets that can be utilized in this process include the following. First, the ticket should include some type of verifiable information that can be utilized to verify that the ticket came from a particular content distributor. This verifiable information can assume any suitable form. For example, the verifiable information can take the form of a certificate associated with the content distributor and verifiable through a chain to a trusted root. Second, the ticket should include an identification of the protected content with which it is associated. This identification can take any suitable form. For example, the identification may comprise a unique ID that is associated with the protected content. In addition, in at least some embodiments, the ticket can be signed by the content provider. For example, the content provider may build a ticket that includes information that identifies a particular content distributor, as well as the protected content, and sign the ticket with its private key. Now, when the ticket is provided to the license server, the license server will be able to use the public key of the content provider to access the ticket's content and verify that the content distributor is authorized by the content provider to distribute that particular content.

The above-described embodiments pertain to a server-side verification process. Specifically, in the above-described examples, a license server is used to verify, via a ticket, that the content distributor associated with particular distributed content is authorized to distribute that content. In other embodiments, verification can take place on the client side. Client-side verification can be useful and certain off-line scenarios.

Implementation Example—Client-Side Verification

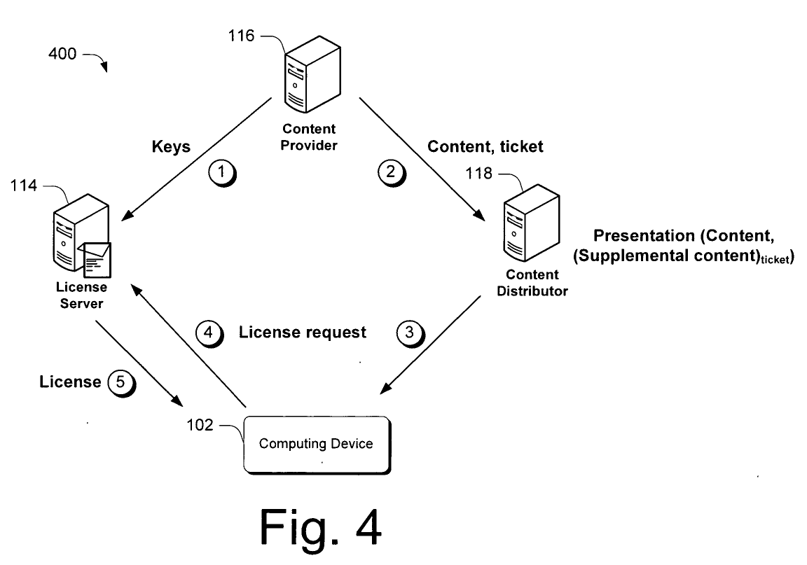

FIG. 4 illustrates a system 400 similar to that shown in FIG. 2, but in which verification takes place on the client side. Specifically, in this example, content provider 116 provides protected content and a ticket to content distributor 118. The content distributor uses the protected content to build a presentation that includes supplemental content. As in the example above, the supplemental content can include any suitable supplemental content such as advertising and the like. In this particular example, the content distributor uses the ticket to sign the supplemental content. The presentation can then be provided to a user of computing device 102.

When a media player application on computing device 102 receives the presentation from content distributor 118, it requests a license from license server 114. The license server returns a license to the media player application that can allow the user to access and play the protected content. In this particular example, the license can include a statement that indicates that digital rights management software on computing device 102 should allow the protected content to be consumed if some definable condition has been satisfied. In this particular example, the definable condition pertains to whether the supplemental content has been signed by the ticket received by the content distributor from the content provider.

If the supplemental content is determined to have been signed by the ticket, then the protected content can be consumed. Otherwise, the protected content cannot be consumed.

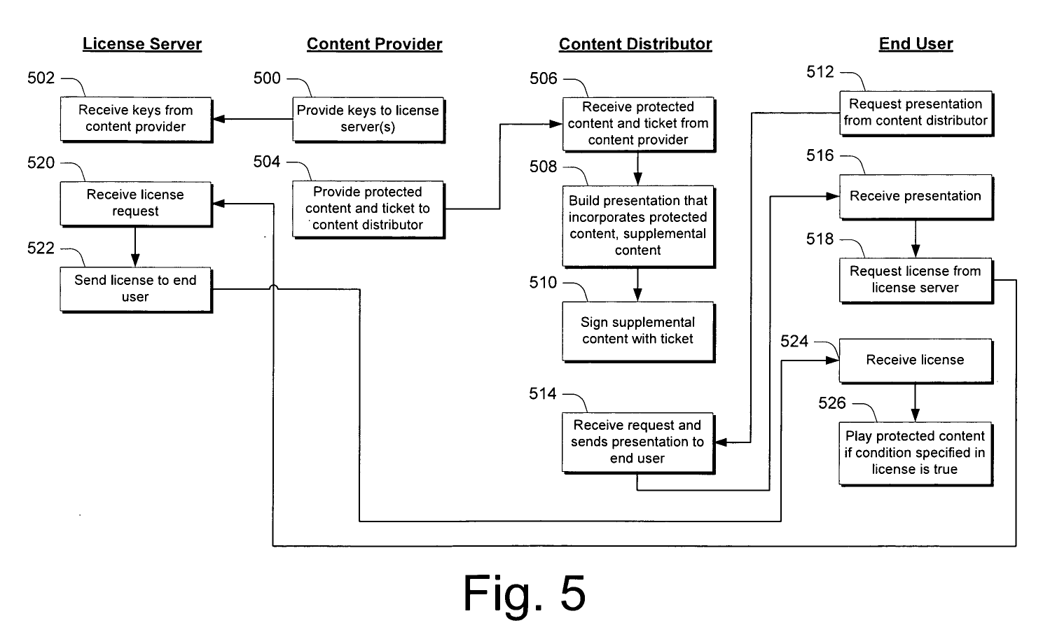

FIG. 5 is a flow diagram that describes steps in a content distribution method in accordance with one or more embodiments. The method can be implemented in connection with any suitable hardware, software, firmware or combination thereof. In at least some embodiments, the method can be implemented using a system such as that shown and described in FIGS. 1 and 2. In FIG. 5, various designations have been utilized to designate which entities perform which acts, as in the flow diagram above.

Step 500 provides, by a content provider, one or more keys to one or more license servers. Any suitable keys can be provided to the license servers. In various embodiments, the keys can be utilized to decrypt or otherwise access content that has been protected. Step 502 receives, with a license server, the keys from the content provider. These keys are subsequently utilized by the license server in licenses that are provided to end users, as will become apparent below. Step 504 provides protected content and a ticket to one or more content distributors. Step 506 receives, with the content distributor, the content from the content provider as well as the ticket. Step 508 builds a presentation that incorporates protected content and supplemental content. Any suitable supplemental content can be utilized. But one example of such supplemental content is advertising material. Step 510 signs the supplemental content with the ticket.

Step 512 requests, by the end-user, a presentation from a content distributor. Step 514 receives the request and sends the presentation to the end-user. Step 516 receives the presentation and step 518 requests a license from the license server.

Step 520 receives, with the license server, the license request that was sent by the end-user. Step 522 sends a license to the end-user.

Step 524 receives the license that was sent from the license server, and utilizes the license, at step 526 to play the protected content if one or more conditions that are specified in the license are true. An example of such a condition is provided above. Specifically, in order to access the protected content in the above-example, the supplemental content should have been signed with the ticket issued by the content provider. Once this is verified, the license includes a key that can be utilized to decrypt or otherwise access the protected content.

Example Computing Device

FIG. 6 illustrates an example computing device 600 that can implement the various embodiments described above. Computing device 600 can be, for example, any suitable computing device such as a client device and/or server device.

Computing device 600 includes one or more processors or processing units 602, one or more memory and/or storage components 604, one or more input/output (I/O) devices 606, and a bus 608 that allows the various components and devices to communicate with one another. Bus 608 represents one or more of any of several types of bus structures, including a memory bus or memory controller, a peripheral bus, an accelerated graphics port, and a processor or local bus using any of a variety of bus architectures. Bus 608 can include wired and/or wireless buses.

Memory/storage component 604 represents one or more computer storage media. Component 604 can include volatile media (such as random access memory (RAM)) and/or nonvolatile media (such as read only memory (ROM), Flash memory, optical disks, magnetic disks, and so forth). Component 604 can include fixed media (e.g., RAM, ROM, a fixed hard drive, etc.) as well as removable media (e.g., a Flash memory drive, a removable hard drive, an optical disk, and so forth).

One or more input/output devices 606 allow a user to enter commands and information to computing device 600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

In various embodiments, a content distribution model is provided in which content providers that own content can distribute their content to third-party content distributors who are unaffiliated with the content providers. The content distributors can, in turn, manipulate the content to provide supplemental content, such as advertising and the like, and then distribute the manipulated content to users who are authorized to consume the content. In this way, content providers are relieved of the responsibility of owning or controlling how such other supplemental content is integrated with their protected content. In this manner, manipulation of the content is delegated to third party content distributors. In one or more embodiments, a ticket-based approach is used as a basis to authenticate that third-party distributors are, in fact, authorized to distribute presentations that include the content provider's content. The ticket-based approach can be used for both server-based verification and client-based verification scenarios.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
receiving, by a content distributor, protected content and a ticket associated with the protected content from a content provider;
using the ticket to build a presentation that incorporates the protected content and supplemental content, wherein the ticket includes verifiable information associated with the content distributor and the protected content;
receiving a request for the presentation; and
sending the presentation to an entity that requested the presentation.

2. The method of claim 1, wherein the supplemental content includes advertising material.

3. The method of claim 1, wherein the verifiable information includes a certificate associated with the content distributor.

4. The method of claim 1, wherein the verifiable information includes a certificate associated with the content distributor and an identification associated with the protected content.

5. The method of claim 1, wherein the ticket is signed by the content provider.

6. One or more computer-readable media having computer-readable instructions thereon which, when executed, implement the method of claim 1.

7. A computer-implemented method comprising:
receiving, from an end user, a ticket associated with a presentation that has been built to include protected content from a content provider and supplemental content provided by a content distributor that is unaffiliated with the content provider;
using the ticket to verify that the content distributor is authorized to distribute the protected content;
responsive to verifying that the content distributor is authorized to distribute the protected content, sending a license to the end user, wherein the license enables the end user to consume the protected content.

8. The method of claim 7, wherein the supplemental content includes advertising material.

9. The method of claim 7, wherein the ticket includes a certificate associated with the content distributor.

10. The method of claim 7, wherein the ticket includes a certificate associated with the content distributor and an identification associated with the protected content.

11. The method of claim 7, wherein the ticket is signed by the content provider.

12. One or more computer-readable media having computer-readable instructions thereon which, when executed, implement the method of claim 7.

13. A computing device embodying the one or more computer-readable media of claim 12.

14. A computer-implemented method comprising:
requesting a presentation from a content distributor, wherein the presentation includes protected content from a content provider and supplemental content that has been added by an entity other than the content provider, wherein the presentation has been built using a ticket that includes verifiable information associated with the content distributor and the protected content;
receiving the presentation;
sending the ticket to a license server;
receiving, from the license server, a license that can enable the end user to consume the protected content.

15. The method of claim 14, wherein the act of sending is performed responsive to attempting to play the presentation.

16. The method of claim 14, wherein the supplemental content includes advertising material.

17. The method of claim 14, wherein the verifiable information includes a certificate associated with the content distributor.

18. The method of claim 14, wherein the verifiable information includes a certificate associated with the content distributor and an identification associated with the protected content.

19. The method of claim 14, wherein the ticket is signed by the content provider.

20. One or more computer-readable media having computer-readable instructions thereon which, when executed, implement the method of claim 14.

21. A computer-implemented method comprising:
requesting a presentation from a content distributor, wherein the presentation includes protected content from a content provider and supplemental content that has been added by the content distributor, wherein the presentation has been built using a ticket in a manner that can satisfy a condition that is specified in a license to play the protected content;
receiving the presentation;
requesting a license associated with the presentation from a license server;
receiving the license from the license server; and
playing the protected content if a condition specified in the license is satisfied.

22. The method of claim 21, wherein the condition pertains to whether the supplemental content has been signed by the ticket.

23. The method of claim 21, wherein the condition pertains to whether a portion of the presentation has been signed by the ticket.

24. The method of claim 21, wherein the supplemental content includes advertising material.

25. One or more computer-readable media having computer-readable instructions thereon which, when executed, implement the method of claim 21.

26. A computing device embodying the one or more computer-readable media of claim 25.
